(19) United States
(12) Patent Application Publication
(10) Pub. No.: US 2018/0050311 A1
(43) Pub. Date: Feb. 22, 2018

(54) Method and Apparatus for Rapidly Aerating Wine

(71) Applicant: Daniel Kuperman, (US)

(72) Inventors: Daniel Kuperman, Thornton, CO (US); Chris Crowley, Golden, CO (US); Dean Miller, Littleton, CO (US); Michael Allen, Superior, CO (US); Robert Nichols, Thornton, CO (US)

(73) Assignee: Daniel Kuperman, Thornton, CO (US)

(21) Appl. No.: 15/680,004

(22) Filed: Aug. 17, 2017

Related U.S. Application Data
(60) Provisional application No. 62/376,315, filed on Aug. 17, 2016.
(60) Provisional application No. 62/444,133, filed on Jan. 9, 2017.
(60) Provisional application No. 62/476,230, filed on Mar. 24, 2017.

(51) Int. Cl. B01F 3/04; A47G 19/22

(52) U.S. Cl. CPC B01F 3/04099; A47G 19/2205; A47G 2400/04; B01F 2215/0072; B01F 3/04531

(57) ABSTRACT

Embodiments of the invention relate to devices and novel methods of aerating single servings of wine. Embodiments disclosed herein comprise an electrically-powered stirring mechanism into a wine receptacle. Embodiments further comprise a power source for the stirring mechanism, and a method to charge the power source. In certain embodiments, a stirring mechanism is positioned in a wine receptacle.

### CROSS-REFERENCE TO RELATED APPLICATIONS

This application claims benefit to U.S. Provisional Patent Application No. 62/376,315 filed Aug. 17, 2016, entitled “Method and Apparatus for Rapidly Aerating Wine”, U.S. Provisional Patent Application No. 62/444,133 filed Jan. 9, 2017, entitled “Method and Apparatus for Rapidly Aerating Wine”, and U.S. Provisional Patent Application No. 62/476,230 filed Mar. 24, 2017 entitled “Method and Apparatus for Rapidly Aerating Wine”, each of which are incorporated by reference in their entirety for all intents and purposes.

### BACKGROUND OF THE INVENTION

Wine is an important social and cultural aspect in many societies. In addition to the health benefits, wine facilitates discussion and is an important part of many religious ceremonies. Wine is often included in many leisure activities, also, which are important for mental health.

Consumption of wine often involves proper preparation, which includes “breathing” for many wines. Breathing is the process of exposing the wine to air. This exposes the aromas of the wine, and can have a softening effect on the taste. Overall flavor characteristics may improve in many wines when exposed to air.

It is often not feasible to let wine breathe in the bottle or container it was supplied in, because of the limited exposure to air within the container. To address this, other methods of promoting wine aeration have been developed, such as a wine decanter. Wine aeration occurs at the air-wine interface. The pace of aeration may be affected by the surface area of wine that is exposed at the interface, and by the oxygen content in air. The function of a wine decanter is therefore to increase the amount of wine surface area in contact with the air.

While decanters exist to promote greater surface area (and, thus, increased rate of oxygenation at the interface between wine and air), such a method of oxygenation does not promote internal oxygenation, and often take a long time to sufficiently aerate a wine. It is often inconvenient to let a wine sit for a long time before enjoying it, particularly at the end of a long day, when it is most desired. Aeration is still limited to the air-wine interface. Further, such decanters are typically useful for an entire bottle of wine, but less practical for smaller volumes, such as a glass of wine.

Alternative methods of aerating wines also exist, such as pour-through devices. These devices are limited to a “one-size-fits-all” technique, however, in that the wine is poured through the device once, and a specified amount of aeration will occur during the pour. Many wines need much more aeration, however, rendering a pour-through device insufficient. It is generally unwieldy to continue pouring from one wine glass to another through an aeration device in order to achieve the appropriate amount of aeration with such wines, particularly if only slightly more aeration is needed. While pour-through devices may produce more surface area than decanters, they produce no internal agitation, which could greatly speed the process. Pour-through devices are also poor at displaying a wine's aroma, which is an important part of the experience associated with drinking wine.

Stirring wines can be beneficial for two reasons. First, stirring fluids increases the surface area of the fluid in contact with the air. The greater air contact promotes greater oxygen exchange with the fluid. Second, stirring fluid induces agitation. Agitation can cause internal air bubbles, further increasing oxygenation.

By stirring fluid, a more even oxygenation process can also occur. By spreading out the fluid volume more thinly and encouraging oxygenation internal to the volume, oxygenation is distributed more evenly throughout the volume. This is in contrast to the common practice of letting a fluid sit exposed to air, unperturbed. In this method of aeration, oxygenation is limited to the air-fluid interface. Fluid near the surface will therefore oxidize more rapidly than fluid deep in the volume. Because some wines require 2 hours to aerate in this method, the gradient of oxidized wine near the top and non-oxidized wine near the bottom can be profound. Wine near the top may even begin to become overly aerated by the time deeper wine has begun aerating.

In addition to providing a more even aeration, stirring action catalyzes more aerosolization of the aromas. Wine aroma is considered an important feature of a wine, as it helps to prepare a drinker's palate and state of mind to more fully enjoy the wine, and therefore enjoy a greater benefit. The display of a wine's aroma can likewise take significant time using conventional “breathing” methods.

While it is possible to manually stir a wine to achieve these benefits, it is often inconvenient to attend to a wine for long periods to regularly stir it, particularly for wines that require a long time to aerate.

Stir-based aeration can be preferable in certain circumstances because the process can be accomplished much more quickly. While younger, highly tannic red wines may require 1 to 2 hours to properly aerate using conventional methods, the same result might be achieved in minutes or even seconds by stirring the wine.

Existing methods of aerating wine with stirring action include the use of a food processor or blender, after which the wine can be poured into a wine glass. Alternatively, an immersion blender in a wine glass is another option. Both of the options, however, are inconvenient—particularly if more aeration is preferred after a first attempt—and often also messy.

### SUMMARY OF THE INVENTION

Embodiments of the invention relate to devices and novel methods of aerating single servings of wine. Embodiments disclosed herein comprise an electrically-powered stirring mechanism into a wine receptacle. Embodiments further comprise a power source for the stirring mechanism, and a method to charge the power source. In certain embodiments, a stirring mechanism is positioned in a wine receptacle. In such embodiments, wine can be added to the wine receptacle, the battery can be charged, and a switch, such as a trigger can be used to bridge a circuit between a power source and a motor. Other embodiments also comprise a base, which serves to both display one or more wine receptacles and to charge the power source. Compatible connectors are included in these embodiments that allow a user to removably connect a wine receptacle to a base in a manner that charges a power source. In these embodiments, the stirring mechanism can take on a function much like a blender, and introduces air into the wine. The stirring mechanism can be powered for as long as a user engages a trigger, allowing a user to aerate any given glass of wine to taste. A user can therefore aerate only the amount of wine desired without committing to an entire bottle of wine. A user can continue to aerate an individual glass of wine, if necessary. Embodiments disclosed herein are advantageous in their ability to aerate a single glass of wine rapidly and to taste.

These and other advantages will be apparent from the disclosure of the invention(s) contained herein. The above-described embodiments, objectives, and configurations are neither complete nor exhaustive. As will be appreciated, other embodiments of the invention are possible using, alone or in combination, one or more of the features set forth above or described in detail below. Further, this Summary is neither intended nor should it be construed as being representative of the full extent and scope of the present invention. The present invention is set forth in various levels of detail in this Summary, as well as in the attached drawings and the detailed description below, and no limitation as to the scope of the present invention is intended to either the inclusion or non-inclusion of elements, components, etc. in this Summary. Additional aspects of the present invention will become more readily apparent from the detailed description, particularly when taken together with the drawings.

### DESCRIPTION OF FIGURES

FIG. 1: A cutaway view of a wine receptacle.

FIG. 2: A cutaway of a wine receptacle showing an embodiment of a stirring mechanism.

FIG. 3: A perspective view of a wine receptacle.

FIG. 4: A view showing an embodiment of a stirring mechanism.

FIG. 5: A perspective view of a base.

FIG. 6: A cutaway view of a wine receptacle.

FIG. 7: A cutaway view of certain embodiments of a wine receptacle including a motor housing.

FIG. 8A: A top view of a wine receptacle in certain embodiments.

FIG. 8B: A side view of a wine receptacle in certain embodiments.

FIG. 8C: A side cross-sectional view of cut-out A-A in FIG. 8B in certain embodiments.

FIG. 9A: A bottom view of a motor connector in certain embodiments.

FIG. 9B: A bottom view of a motor connector in certain embodiments.

FIG. 9C: A view of a base connector in certain embodiments.

FIG. 9D: A view of a base connector in certain embodiments.

### DETAILED DESCRIPTION OF VARIOUS EMBODIMENTS OF THE INVENTION

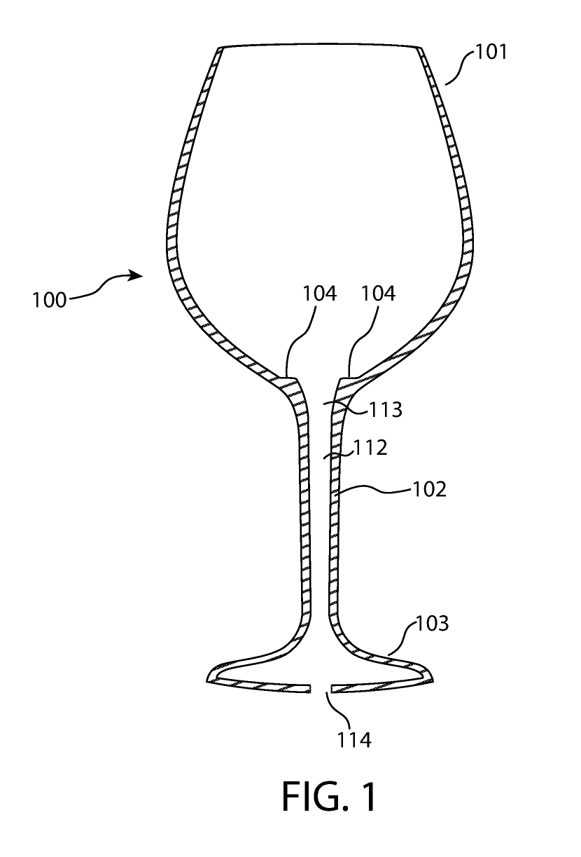

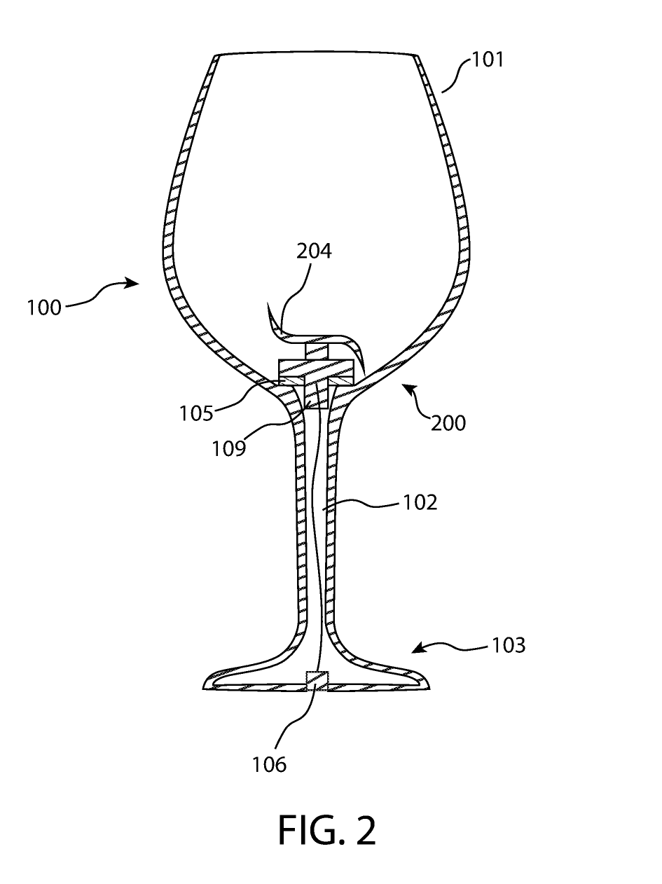

In certain embodiments, as seen in FIGS. 1 and 2, the present invention comprises a wine receptacle 100, which can be made of glass, crystal, or other material appropriate for a wine glass. Embodiments comprise a container adapted to hold fluid, such as bowl 101. Embodiments further comprise a stem 102 and a foot 103. As seen in FIG. 1, the shape of the wine receptacle 100 is such that the stem 102 and foot 103 are hollow, forming a contiguous channel 112 into the bowl 101 In certain embodiments, a channel 112 extends from a first opening 113 to a second opening 114. A notch 104 is formed on the inner surface of the bowl 101 near the bottom in order to support a sealing ring 105, which will define a watertight boundary.

The wine receptacle 100 further comprises a stirring mechanism 200 (as seen in FIGS. 2, 3 and 4). In certain embodiments, stirring mechanism 200 is positioned at the bottom of the bowl 101, as can be seen in FIGS. 2, 3 and 4.

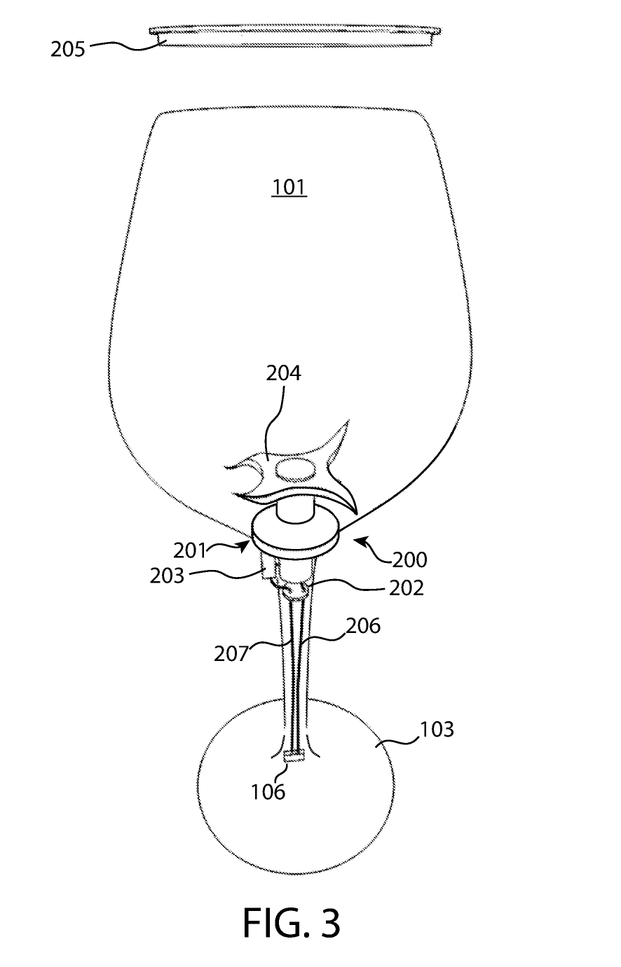

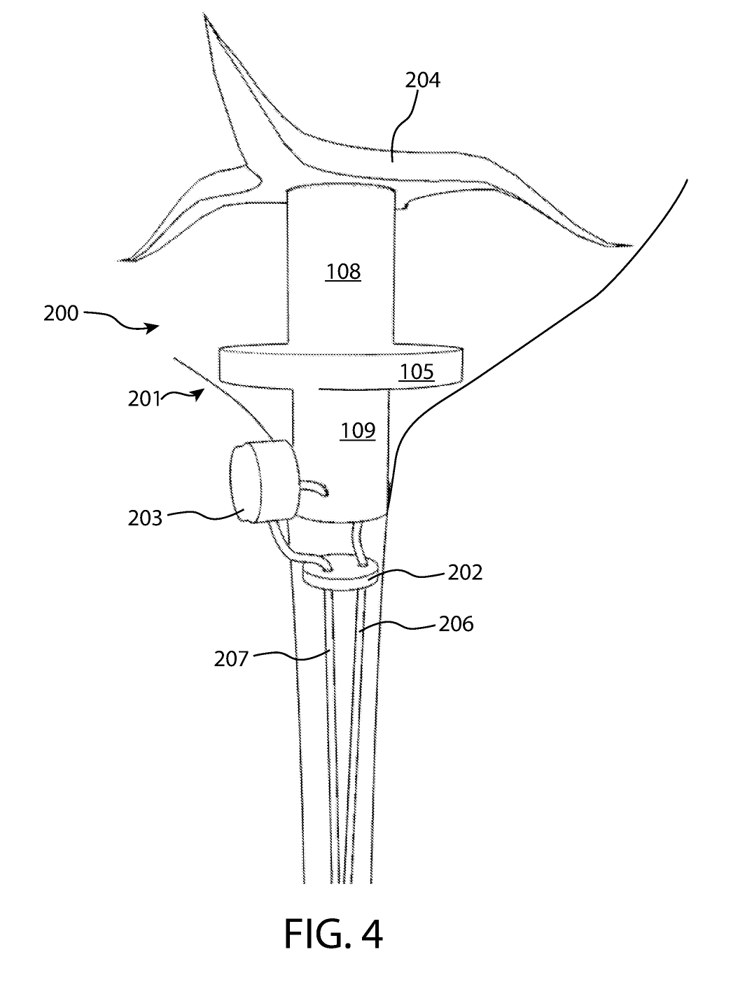

As seen in FIG. 3, a motor 201 is positioned at the junction of the bowl 101 and stem 102, and draws power from the power source 202 through insulated copper wires or other such wiring as known to those skilled in the art. As seen in FIGS. 3 and 4, a direct wire 206, which is one of the wires, such as the wire attached to the negative terminal of the battery, forms a contiguous link from the battery to the motor. The other wire, such as the wire connected to the positive terminal of the battery, is interrupted along its length by a trigger 203, and is the indirect wire 207, as can be seen in FIGS. 3 and 4. The trigger 203 can be a switch or button, which, when activated, completes the circuit between the motor and the battery, which turns the motor on. In certain embodiments, a trigger includes a switch, such as a light-touch switch. In certain embodiments, a switch is a Panasonic® EVQPo or a EVQQ2 mechanical switch or the like. As seen in FIG. 4, the motor 201 can be used to drive rotation of the stirring blades 204 around a principal axis when turned on. The motor, in certain embodiments comprises a diameter of 6 millimeters (mm), a length of 15 mm, shaft diameter of 0.8 mm, have a load speed of around 65000+/−15% RPM and a rated load speed of 38500+/−15% RPM. Embodiments of the invention may throttle down the motor to reduce the RPM speed.

In certain embodiments of the present invention, the stirring blades run at a speed that is vigorous enough to aerate the wine, but also so there is no overflow of the wine or other liquid in the bowl. The stirring blades may be on a 180-degree plane. In other embodiments, the stirring blades may have an angle configured in a “V” shape. In certain embodiments, the stirring blades run at a speed in a range of 4500 to 9000 revolutions per minute (RPM). In yet another embodiment, there may be more than 2 stirring blades, with an angled configuration similar to a propeller or fan.

In yet another embodiment, the trigger 203, as seen in FIGS. 3 and 4 is positioned near the junction of the bowl 101 and the stem 102. The power source 202 is positioned beneath the trigger 203 in the stem 102. The position of the power source 202 and trigger 203 may be positioned in this way, with respect to the electric motor 201, in order to maximize efficiency and provide the shortest route possible for connecting wires. It will be appreciated that the position of the power source 202 is not limited to a location beneath a trigger in certain embodiments.

As seen in FIG. 4, stirring mechanism 200 comprises a motor 201, a power source 202, a trigger 203, and stirring blades 204.

As can be seen in FIG. 4, the upper housing 108 for the electric motor 201 is positioned above the sealing ring in the bottom of the bowl 101. In certain embodiments, a housing contains a motor that drives the rotating motion of stirring blades 204. In certain embodiments, a motor drive shaft connects to the stirring blade 204. The lower housing 109 of the electric motor 201 extends through the center of the sealing ring 105, across a watertight boundary. The boundary between the sealing ring 105 and the wine receptacle 100 and the boundary between the sealing ring 105 and the lower housing 109 are made watertight through the addition of a watertight boundary. The watertight boundary may comprise a rubber component (such as an o-ring) or an epoxy to adjoin the two surfaces. The O-ring can be a silicone material, 60 durometer, food grade or the like. One skilled in the art will recognize a plurality of means for adjoining two surfaces in a non-toxic way that seals fluid. The sealing ring therefore forms a contiguous seal between the wine receptacle 100, at the position of the notch 104 (as can be seen in FIG. 1), and the lower housing 109 of the electric motor.

The motor 201 drives stirring blade 204, which rotates in such a way as to draw air from the top of the wine receptacle 100 down to the center in a vortex. The shape of the stirring blades 204, as seen in FIGS. 2, 3 and 4, may be such that they encourage containment of fluid within the wine receptacle 100, such as a downward movement of the fluid they pass through, in order to help contain the wine within the wine receptacle 100. The specific shape of the motor 201 may orient the blades 204 in an upward direction, a downward direction, an oblique direction, a variable direction, or some combination of these, and may be configured based on the specific shape of the wine receptacle 100, in order to encourage the containment of fluid during aeration. The form factor of the blades 204 may have varying degrees of edge sharpness and cross sectional area.

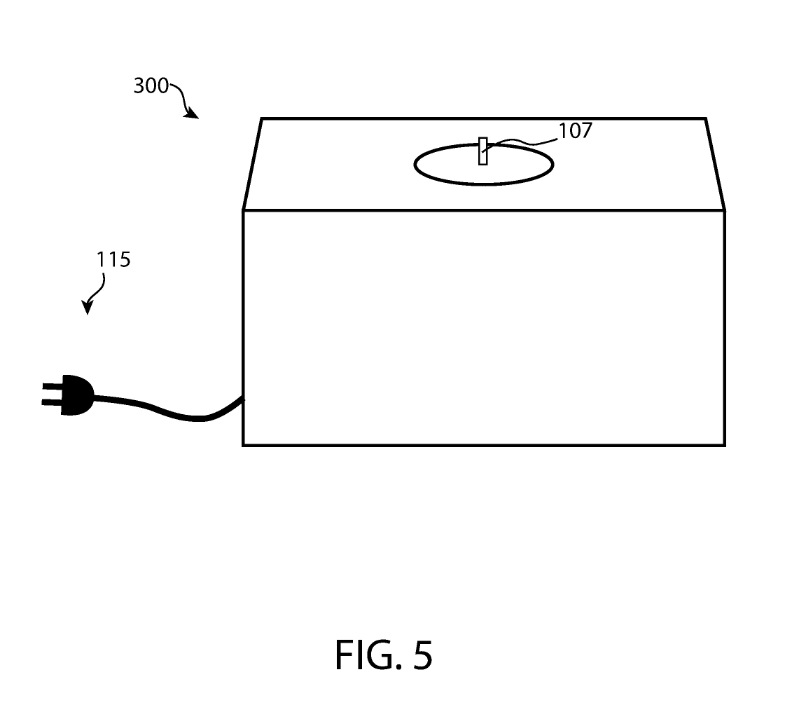

Certain embodiments of the invention further comprise a base 300, as seen in FIG. 5. A base incorporates a way to display one or more wine receptacles 100 (seen in FIG. 1). In certain embodiments, a base 300 further comprises a mechanism to provide power to a wine receptacle 100. The mechanism of providing power draws power from electrical outlets, and comprises an AC to DC converter, and an appropriate electrical plug 115 for the locality, such as a Type A electrical plug in the United States. This mechanism draws electrical power from an electrical outlet and provides it to the wine receptacle 100 via a connection between the motor connector 106 (seen in FIGS. 2 and 3) and the base connector 107.

The motor connector 106, (seen in FIGS. 3 and 4), and base connector 107, (seen in FIG. 5), comprise an electrical connection between the wine receptacle 100 and the base 300. In certain embodiments, the connectors may comprise a plastic, two port push connector. One skilled in the art will recognize a plurality of ways to removably connect the wine receptacle 100 and the base in a way that transmits electrical power. For example, in certain embodiments, the base comprises a printed circuit assembly (PCA) and a USB power input connection. Certain embodiments comprise a plurality of base connectors.

For example, in certain embodiments, the power source 202, as seen in FIGS. 2 and 3, comprises a rechargeable battery. The battery may comprise a Polymer Lithium Ion rechargeable battery, such as a battery made by Data Power Technology Limited, Model Number DTP301120 or the like. The power source 202 may sit in a housing, such as one formed by internal molding of the stem 102. The power source 202 is connected to insulated copper wires that run down the stem 102, and terminate in a motor connector 106. The base 300, seen in FIG. 5, comprises a complementary connector, a base connector 107, which can be attached to the motor connector 106 in order to provide power and recharge the power source 202. Certain embodiments of the present invention comprise a lithium ion and lithium polymer battery charger based on the MCP73833.

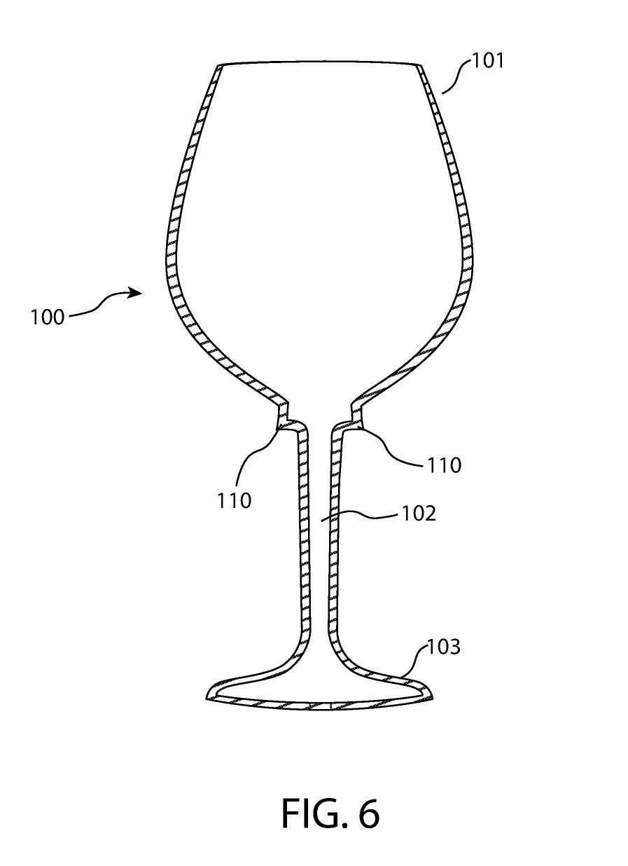

In other embodiments, as seen in FIG. 6, the wine glass 100 is configured in such a way as to house the motor 201. The configuration incorporates a radial expansion 110 at the junction of a bowl 101 and a stem 102. The expansion 110 includes a shape, such as a cylindrical shape to house a motor 201.

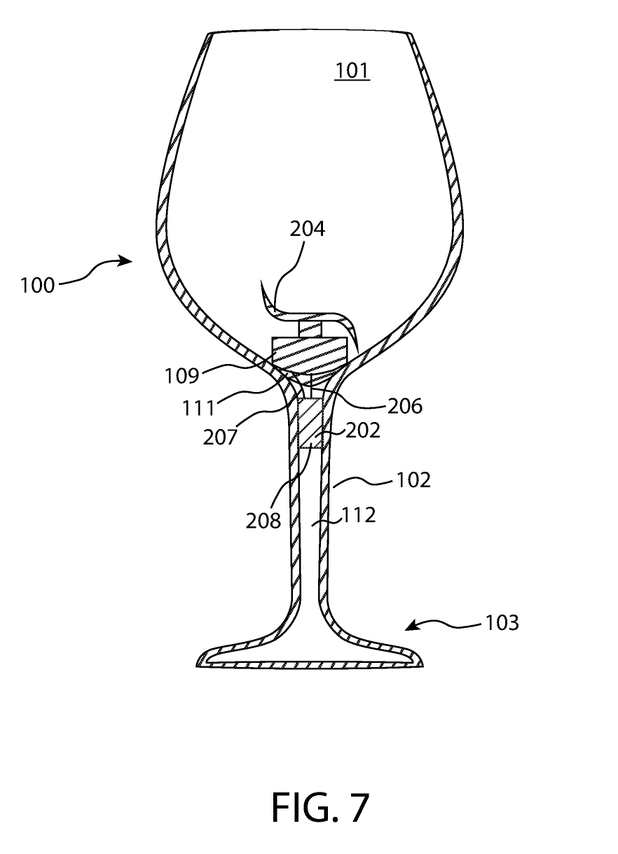

FIG. 7 shows another embodiment of wine glass 100. Such an embodiment may be comprised of a lower housing 109 that is configured to fit the bottom surface of a bowl 101. In such an embodiment, a watertight boundary may be provided by a plastic guard or seal 111. A plastic guard 111 prevents liquid from entering the channel 112 where a power source 202 is housed below.

As seen in FIGS. 4 and 7, certain embodiments comprise an alternative power source 202. The power source 202 may comprise direct current from a battery. In such an embodiment, power housing 208 for a power source 202 may be incorporated into the wine glass 100, such as near the top of the stem 102, for example. Such an embodiment further comprises power transmission, such as copper wires ensheathed in plastic-based insulation. Insulated wires such as those capable of serving as direct wire 206 and indirect wire 207 are intended to carry electrical current capable of powering blender motor 201 from power source 202 to blender motor 201. Wires and wire insulation extends from lower housing 109 to power housing 208. Wire insulation is contiguous with plastic guard 111, providing a watertight boundary that excludes liquid from below plastic guard 111.

Still referring to FIGS. 4 and 7, power source 202 may be comprised of a battery. In such an embodiment, the battery may comprise a standard disposable battery, or a rechargeable battery. Certain embodiments include a power source from a battery having a voltage of 6V or more, although it will be appreciated that less than 6V may be used for certain embodiments. Certain embodiments include a Ni-MH or a lithium ion battery. Certain embodiments include a multi-cell battery or a battery pack. Certain embodiments may also incorporate necessary components for wireless charging. In such an embodiment, a charging base is used to convert voltage into high frequency alternating current. Alternating current is sent to a transmitter coil by a transmitter circuit, where the alternating current then induces a time varying magnetic field. Such an embodiment further comprises a receiving coil, such as in the power housing 208, for example. The magnetic field produced by the transmitter coil generates current in the receiving coil. Current in the receiving coil is converted back into direct current, and used to charge the power source 202.

In certain embodiments, power source 202 may be incorporated into lower housing 109. Such embodiments may be preferable to reduce component requirements, such as wires and plastic guard 111. In such embodiments, external power housing 208 may be incorporated into lower housing 109. One skilled in the art will appreciate the need for power housing 208 in certain embodiments and not in others. In certain embodiments, power source 202 is comprised of solar power.

In certain embodiments, a user can pour wine into the wine receptacle 100. Any wine remaining in the bottle can be preserved by known methods without being aerated. As seen in FIG. 3, once the desired amount of wine has been poured, a lid 205, may be positioned over the wine receptacle 100 to cover the bowl 101 and prevent the wine from spilling. Once the lid 205 is secured, the trigger 203 may be depressed, which closes the circuit between the electric motor 201 and the power source 202, which initiates rotation of the stirring blades 204, driven by the electric motor 201, thus aerating the wine. A user can further aerate the wine between drinks or as desired to suit his or her taste.

Because different wines may benefit from different bowl 101 and stem 102 shapes, a wine receptacle 100 may comprise a plurality of form factors. In an embodiment, a wine receptacle has a form factor resembling a “Bordeaux Glass.” Such an embodiment may be appropriate for specific wines, such as a Cabernet Sauvignon. In alternative embodiments, the form factor of the wine receptacle 100 may instead resemble a “Burgundy Glass,” making it appropriate for wines such as a Pinot Noir. One skilled in the art will recognize a plurality of shapes appropriate for a variety of wines, which include, but are not limited to, those specific to a syrah or shiraz, those appropriate for a tempranillo or rioja, and those appropriate for a zinfandel or chianti.

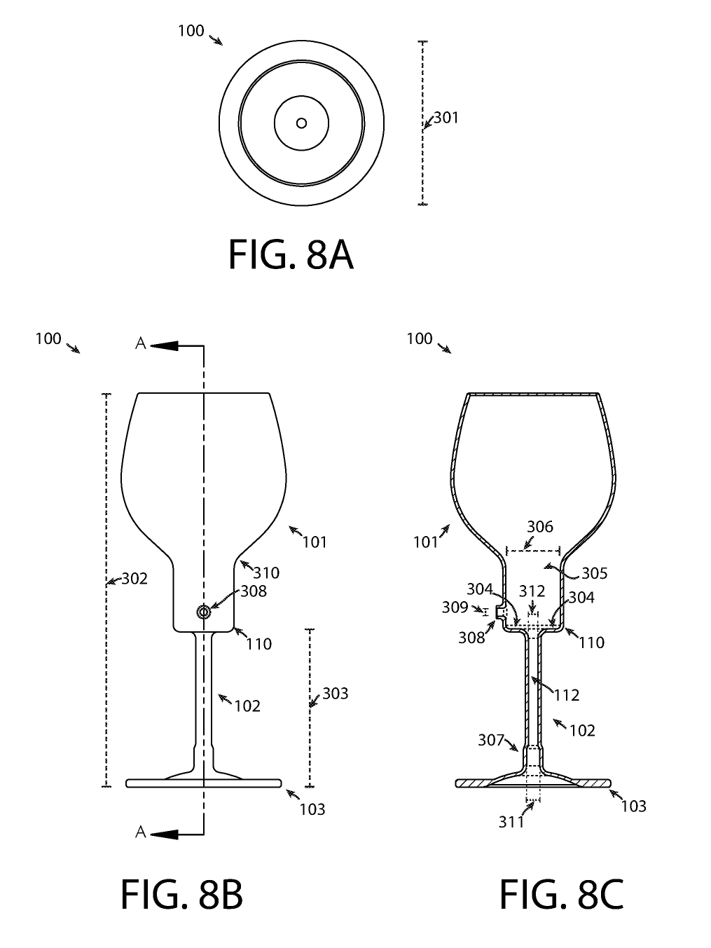

Referring to FIG. 8A, certain embodiments of a wine receptacle 100 has a certain width 301. In certain embodiments, a width 301 is approximately, but not limited to, 7.9 cm (3.1 inches). Referring to FIG. 8B, certain embodiments of a wine receptacle 100 has a height 302. In certain embodiments, a height 302 is approximately, but is not limited to, 19 cm (7.5 inches). In certain embodiments, a bowl 101 further includes an expansion 110 located near a lower end 310, where the expansion 101 is attached to a stem 102. A stem 102 (and in certain embodiments, a stem 102 and a foot 103) has a length 303. In certain embodiments, a length 303 is 7.6 cm (3.0 inches). In certain embodiments, a stem 102 has a channel 112 with an internal diameter 312. In certain embodiments, such internal diameter 312 is approximately in the range of, but not limited to 0.38 cm (0.15 inches) to 0.64 cm (0.25 inches). As seen in FIG. 8C, in certain embodiments, a stem 102 further includes a stem radial expansion 307 located between a stem 102 and a foot 103. In certain embodiments, a stem radial expansion 307 has an internal diameter 311 larger than a stem internal diameter 312. In certain embodiments, such stem radial expansion internal diameter 311 is approximately, but not limited to 0.64 cm (0.25 inches).

In certain embodiments, a wine receptacle 100 includes a third opening 308, for example, located on an expansion 110. It will be appreciated that a third opening 308 is of any shape or size. In certain embodiments, as seen in FIG. 8C, a third opening 308 has a circular opening with an internal diameter 309 of approximately, but not limited to 0.8 cm (0.315 inches). A third opening connects an external region to the interior region of a wine receptacle. Such interior region includes, for example, a channel 112, or a space 305 created by an expansion 110. A third opening 308 allows placement, for example, of a switch 203 (seen in FIG. 4) on an exterior region and/or surface of a wine receptacle. A switch 203 is connected to components within a wine receptacle, including for example, a motor and battery.

Referring to FIG. 8C showing a cross-sectional view, certain embodiments of a wine receptacle 100 have an expansion 110 with an internal diameter 306 that is approximately, but not limited to, 2.6 cm (1.04 inches). In certain embodiments, an expansion 110 has a shelf 304 that supports certain components, for example, a stirring mechanism.

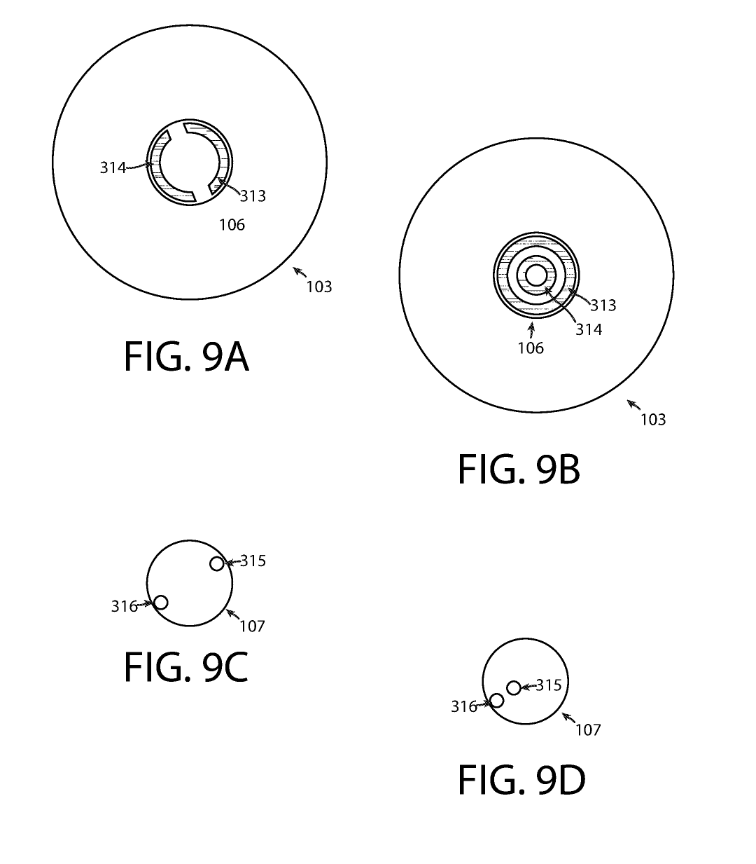

Referring to FIG. 9A and FIG. 9B showing a bottom view, a foot 103 includes a motor connector 106. Electrodes 313, 314 on a motor connector 106 allow electrical conductivity between a stirring mechanism in a wine receptacle with, for example, the base connector 107 (as seen in FIG. 5, FIG. 9C, and FIG. 9D). The arrangement of the electrodes 313, 314 (FIG. 9A and FIG. 9B) match the arrangement of charging pads 315, 316 located on a base connector 107 (FIG. 9C, and FIG. 9D). In certain embodiments, electrodes 313, 314 may be semicircular (as seen in FIG. 9A), annular rings (as seen in FIG. 9B), and other orientations.

While various embodiments of the present invention have been described in detail, it is apparent that modifications and alterations of those embodiments will occur to those skilled in the art. However, it is to be expressly understood that such modifications and alterations are within the scope and spirit of the present invention. Further, the inventions described herein are capable of other embodiments and of being practiced or of being carried out in various ways. In addition, it is to be understood that the phraseology and terminology used herein is for the purposes of description and should not be regarded as limiting. The use of “including,” “comprising,” or “adding” and variations thereof herein are meant to encompass the items listed thereafter and equivalents thereof, as well as, additional items.

What is claimed is:

1. A glass comprising:
a container adapted to hold a quantity of fluid;
a stem connected to the bottom of said container;
a foot connected to said stem at the end opposite of said container;
a stirring component located within said container at a bottom end of said container;
said stirring component having protrusions extending radially outward from the center of said stirring component; and
said stirring component further comprising a power source.

2. The glass of claim 1 wherein said container comprises a bowl shape, said container further comprising a notch on the bottom inner surface of said container.

3. The glass of claim 2 further comprising a sealing ring resting on said notch.

4. The glass of claim 1 wherein said stem is hollow.

5. The glass of claim 4 wherein said stirring component further comprising a switch, said switch located on the external surface of said stem.

6. The glass of claim 1 wherein said protrusions comprise blades.

7. The glass of claim 4 wherein said stirring component further comprising a switch, said switch located on the external surface of said stem.

8. The glass of claim 7 wherein said foot is configured to mount on a base, said base providing an electrical current to said power source, wherein said electrical current provides a charge to said power source.

9. A glass comprising:
a container adapted to hold a quantity of fluid;
a substantially hollow stem connected to the bottom of said container;
a foot connected to said stem at the end opposite of said container;
a stirring component having a power source, said stirring component located within said container at a bottom end of said container; and
a power housing located within said stem, said power housing connected to said stirring component.
